(19) United States
(12) Patent Application Publication
(10) Pub. No.: US 2026/0281768 A1
(43) Pub. Date: Sep. 17, 2026

(54) BACKOFF MECHANISM FOR CHANNEL STATE INFORMATION (CSI) REPORTING USING CONNECTIONLESS UPLINK TRANSMISSION

(71) Applicant: QUALCOMM Incorporated, San Diego, CA (US)

(72) Inventors: Raviteja PATCHAVA, San Diego, CA (US); Jing SUN, San Diego, CA (US); Xiaoxia ZHANG, San Diego, CA (US); Junyi LI, Greentown, PA (US); Thomas Joseph RICHARDSON, South Orange, NJ (US); Jing JIANG, San Diego, CA (US)

(21) Appl. No.: 19/076,812

(22) Filed: Mar. 11, 2025

(51) Int. Cl. H04W 24/10; H04B 7/0456; H04L 5/00; H04W 72/02

(52) U.S. Cl. CPC H04W 24/10; H04B 7/0456; H04L 5/0057; H04W 72/02

(57) ABSTRACT

A method of connectionless uplink (CLUL) wireless communication, at a user equipment (UE) includes selecting a first resource from a first resource pool based on a backoff value corresponding to a change in channel state information (CSI). The method also includes transmitting a CSI report on the first resource, without receiving an explicit uplink grant for the first resource.

### FIELD OF THE DISCLOSURE

Aspects of the present disclosure relate to wireless communications, and more particularly, to a backoff mechanism for channel state information (CSI) reporting using connectionless uplink transmission.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

In aspects of the present disclosure, a method of connectionless uplink (CLUL) wireless communication, at a user equipment (UE), includes selecting a first resource from a first resource pool based on a backoff value corresponding to a change in channel state information (CSI). The method also includes transmitting a CSI report on the first resource, without receiving an explicit uplink grant for the first resource.

In other aspects of the present disclosure, a method of connectionless uplink (CLUL) wireless communication, at a network entity, includes configuring a first resource from a first resource pool based on a backoff value corresponding to a change in channel state information (CSI) at a user equipment (UE). The method also includes receiving a CSI report from the UE on the first resource, without transmitting an explicit uplink grant for the first resource.

Other aspects provide: one or more apparatuses operable, configured, or otherwise adapted to perform any portion of any method described (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described (e.g., such that code may be stored in only one computer-readable medium or across computer-readable media in a distributed fashion); and/or one or more apparatuses comprising one or more means for performing any portion of any method described (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described and are not to be considered limiting of the scope of this disclosure.

FIG. 1 is a block diagram illustrating an example wireless communications network, in accordance with various aspects of the present disclosure.

FIG. 2 is a block diagram illustrating an example disaggregated base station architecture, in accordance with various aspects of the present disclosure.

FIG. 3 is a block diagram illustrating aspects of an example base station and an example user equipment (UE), in accordance with various aspects of the present disclosure.

FIGS. 4A, 4B, 4C, and 4D are block diagrams illustrating various example aspects of data structures for a wireless communications network.

FIG. 5 is a process flow for closed-loop feedback associated with a communication channel between a network entity (NE) and a UE, according to various aspects of the present disclosure.

FIG. 6 is a block diagram illustrating a resource pool of resources grouped and associated with connectionless uplink (CLUL) transmissions, according to various aspects of the present disclosure.

FIG. 7 is a diagram illustrating collisions in CLUL transmissions.

FIG. 8 is a diagram illustrating a specific resource allocation, in accordance with various aspects of the present disclosure.

FIG. 9 is a diagram illustrating a nested resource allocation, in accordance with various aspects of the present disclosure.

FIG. 10 is a flow diagram illustrating an example process for communicating information from a user equipment (UE) via connectionless uplink resources, according to various aspects of the present disclosure.

FIG. 11 is a flow diagram illustrating an example process for communicating information, at a network entity, via connectionless uplink resources, according to various aspects of the present disclosure.

### DETAILED DESCRIPTION

Aspects of the present disclosure provide apparatuses, methods, processing systems, and computer-readable mediums for using connectionless uplink resources to facilitate channel state information (CSI) reporting.

Communications on wireless networks are generally undertaken via a network-controlled and connection-based architecture relying on common protocols between user equipment (UEs) and base stations or other network entities (NEs). UEs may send uplink transmissions to NE(s) to request uplink resources. NE(s) may grant resources, such as frequency resources or time resources (collectively and interchangeably referred to as “resources”), by transmitting information to the UEs to allow use of the granted resources by the UEs. In this traditional grant-based connection approach, an NE knows the exact resource that a UE will use, because the NE has determined the resource to be used, and the UE is expected to use the resource that is granted. On the other hand, a “connectionless” transmission or communication (also referred to as grantless transmission) is one that occurs without this explicit granting procedure by an NE. For example, a UE may select the resource itself from a configured pool of resources. Connectionless communication may be beneficial because a UE and an NE may be given some flexibility for which resources are to be used for communication. For example, connectionless communication may facilitate a large number of UEs having different capabilities (such as enhanced mobile broadband (eMBB) UEs and Internet of things (IoT) UEs) camping on the same carrier and performing small and/or sparse communications.

A common type of uplink transmission (from a UE to an NE) is a CSI report. CSI reporting may include information or a report on a channel state, which the UE may determine by estimating the channel state using a received reference signal (such as a CSI reference signal (CSI-RS)). The UE may report an estimated channel state to the NE in the form of a CSI report (sometimes referred to as CSI feedback) carrying CSI. In certain aspects, the CSI may indicate channel properties of a communication link between the NE and the UE. For example, the CSI may indicate the effect of scattering, fading, and/or path loss of a signal propagating across the communication link. A CSI report may include a channel quality indicator (CQI), a precoding matrix indicator (PMI) (e.g., precoding feedback), a layer indicator (LI), a rank indicator (RI), a reference signal received power (RSRP), a signal-to-interference plus noise ratio (SINR), etc. Additional or other information may be included in CSI or a CSI report.

CSI reporting in some radio access technologies (RATs), such as long term evolution (LTE) and 5G new radio (5G NR), is driven by the NE (e.g., a next generation NodeB (gNB)). CSI reporting generally falls into one of three categories: periodic reporting, semi-persistent reporting, or aperiodic reporting. Periodic reporting is where CSI reporting is periodically transmitted to NEs from UEs. For example, the UE may be configured with periodic physical uplink control channel (PUCCH) resources on which to transmit the CSI report. If there is an overlapping transmission or a transmission that has already granted physical uplink shared channel (PUSCH) resources, then the uplink transmission for the CSI report may leverage this already granted PUSCH resource instead of the PUCCH resource. In semi-persistent CSI reporting, the NE may use a media access control (MAC) control element (MAC CE) to dynamically activate and deactivate CSI reporting. When activated, the CSI reporting may be performed on a periodic basis until the reporting is deactivated by the NE. In aperiodic reporting, the NE indicates to the UE via downlink channel information (DCI) a CSI report setting indicating when to send CSI, which the UE uses to report CSI to the NE. For example, the DCI may trigger transmission of the CSI.

These different CSI reporting models are all driven by the NE, and therefore, generally involve some amount of explicit signaling and overhead. However, the NE may not ordinarily know a current or most-up-to-date state of the UE and whether it would be useful to receive additional or updated CSI from the UE. This may lead to over-reporting of CSI, thereby incurring overhead when CSI reporting is unnecessary or does not produce a benefit or reflect a change to the channel at the NE or the UE. The UE is generally best placed to determine when reporting should occur, such as when CSI changes are most substantial and worth reporting to the NE to affect a change.

Aspects of the present disclosure describe CSI reporting driven by a UE. This can be implemented by the UE obtaining a configuration or indication for an uplink resource pool associated with CSI reporting and UEs. This resource pool may also be comprised of connectionless uplink (CLUL) resources or are associated with grantless or connectionless uplink transmission. The UE sends CSI on these connectionless resources from the uplink resource pool. “Grantless” may be used interchangeably with “connectionless” In this disclosure.

One technical advantage of this CLUL transmission model of CSI is overhead reduction of CSI reporting. A second technical advantage is the improved efficiency of undertaking CSI transmissions by a UE. A third technical advantage of the CLUL transmission model of CSI is that the total pool of resources available for CSI is pre-defined and limited. A fourth technical advantage is that the UE is able to manage the timing and frequency of NE side actions by controlling when to transmit CSI to the NE. Thus, activity on the NE side and total network overhead may be reduced.

Because the CLUL transmissions are contention-based, CSI reporting of two or more UEs may collide. Aspects of the present disclosure reduce or even minimize such collisions by employing a backoff mechanism based on a CSI report. A backoff refers to a delayed transmission at the UE. The backoff may be based on a change in CSI, such that UEs with a lower change of CSI may transmit later than UEs with a higher change of CSI. For example, a UE may apply the backoff based on one or more of a change in rank indicator (RI), a change in a channel quality indicator (CQI), and/or a change in a precoding matrix indicator (PMI) or a long term channel properties matrix (e.g., a W1 matrix).

According to aspects of the present disclosure, the NE may reserve a set of resources in the resource pool for a given CSI change. The UE then randomly selects a resource in the set based on a CSI change. The resources may be specifically allocated or may be a nested allocation.

Other aspects of the present disclosure relate to reliable delivery of packets, including reception acknowledgement and retransmission mechanisms for CLUL communications. In a first option, acknowledgements and negative acknowledgements (ACK/NACK) are not transmitted for CSI reports. In a second option, the NE elects to transmit ACK/NACK for a CSI report, or there is a common resource pool for both the CSI report and other uplink data. In this option, the NE may transmit DCI with ACK/NACK bits mapping to CLUL resource identifiers (IDs). Alternatively, the NE transmits user ID specific ACK feedback. In another implementation of the second option, the NE transmits downlink control information with an explicit uplink grant.

Aspects described refer to connectionless uplink transmission. It should be noted that connectionless uplink transmission can be performed while the UE has a connection to the network entity. Reference to “connectionless uplink transmission” should be understood to also encompass grantless uplink transmission.

### Introduction to Wireless Communications Networks

The techniques and methods described may be used for various wireless communications networks. While aspects may be described using terminology commonly associated with 3G, 4G, 5G, 6G, and/or other generations of wireless technologies, aspects of the present disclosure may likewise be applicable to other communications systems and standards not explicitly mentioned.

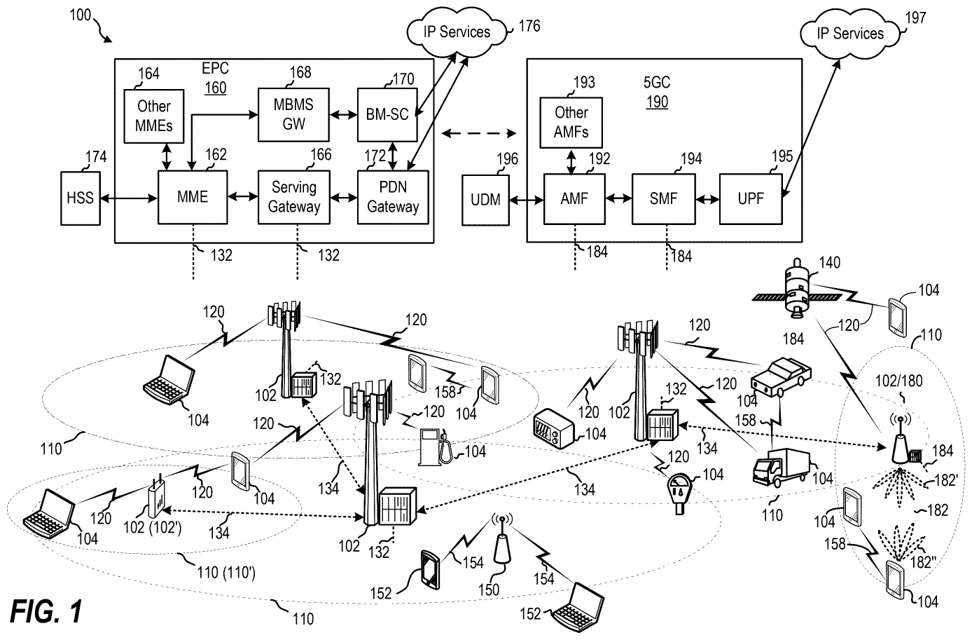

FIG. 1 depicts an example of a wireless communications network 100, in which aspects described may be implemented.

Generally, wireless communications network 100 includes various network entities (alternatively, network elements or network nodes). A network entity is generally a communications device and/or a communications function performed by a communications device (e.g., a base station (BS), a component of a BS, a central unit, a distributed unit, a radio unit, a cloud function, a network function, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to as non-terrestrial network entities), such as satellite 140 and transporter, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an evolved packet core (EPC) 160 and 5G core (5GC) 190 networks, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, Internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

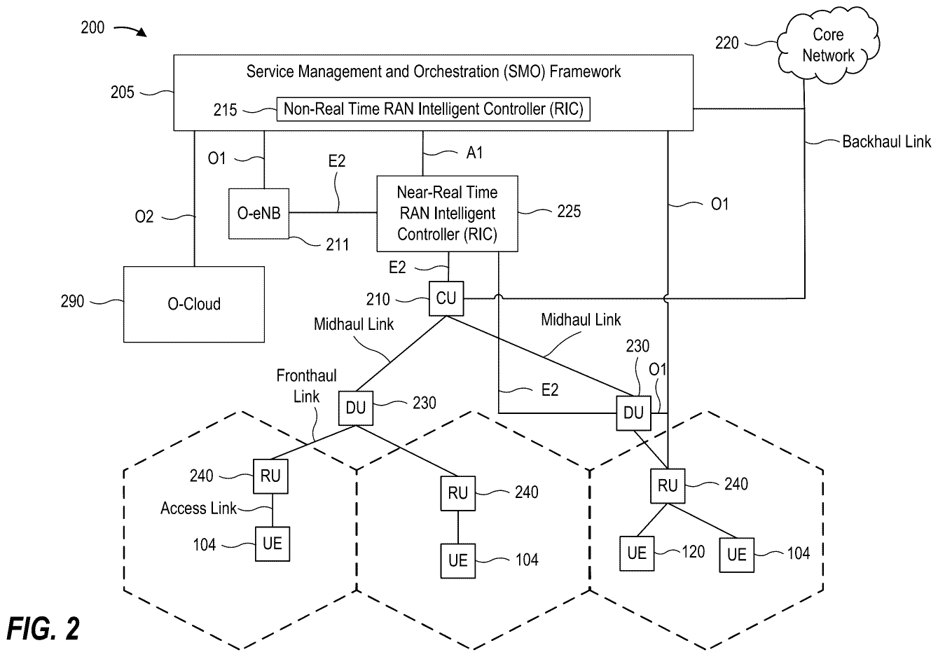

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a near-real time (near-RT) RAN intelligent controller (RIC), or a non-real time (non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network (RAN) architecture, such as an open RAN (O-RAN) or virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as evolved universal mobile telecommunications system (UMTS) terrestrial radio access network (E-UTRAN)) may interface with the EPC 160 through first backhaul links 132 (e.g., an S1 interface). BSs 102 configured for 5G (e.g., 5G NR or next generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz.” Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a WI-FI AP 150 in communication with WI-FI stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a mobility management entity (MME) 162, other MMEs 164, a serving gateway 166, a multimedia broadcast multicast service (MBMS) Gateway 168, a broadcast multicast service center (BM-SC) 170, and/or a packet data network (PDN) Gateway 172, such as in the depicted example. MME 162 may be in communication with a home subscriber server (HSS) 174. MME 162 is the control node that processes the signaling between the UEs 104 and the EPC 160. Generally, MME 162 provides bearer and connection management.

Generally, user Internet protocol (IP) packets are transferred through serving gateway 166, which itself is connected to PDN gateway 172. PDN gateway 172 provides UE IP address allocation as well as other functions. PDN gateway 172 and the BM-SC 170 are connected to IP Services 176, which may include, for example, the Internet, an intranet, an IP multimedia subsystem (IMS), a packet switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a multicast broadcast single frequency network (MBSFN) area broadcasting a particular service, and/or may be responsible for session management (start/stop) and for collecting eMBMS related charging information.

5GC 190 may include various functional components, including: an access and mobility management function (AMF) 192, other AMFs 193, a session management function (SMF) 194, and a user plane function (UPF) 195. AMF 192 may be in communication with unified data management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, or a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a near-real time (near-RT) RAN intelligent controller (RIC) 225 via an E2 link, or a non-real time (non-RT) RIC 215 associated with a Service management and orchestration (SMO) framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the near-RT RICs 225, the non-RT RICs 215 and the SMO framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real time and non-real time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO framework 205 may be configured to support RAN deployment and provisioning of non-virtualized and virtualized network elements. For non-virtualized network elements, the SMO framework 205 may be configured to support the deployment of dedicated physical resources for RAN coverage requirements which may be managed via an operations and maintenance interface (such as an O1 interface). For virtualized network elements, the SMO framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and near-RT RICs 225. In some implementations, the SMO framework 205 can communicate with a hardware aspect of a 4G RAN, such as an open eNB (O-eNB) 211, via an O1 interface. Additionally, in some implementations, the SMO framework 205 can communicate directly with one or more DUs 230 and/or one or more RUs 240 via an O1 interface. The SMO framework 205 also may include a non-RT RIC 215 configured to support functionality of the SMO framework 205.

The non-RT RIC 215 may be configured to include a logical function that enables non-real time control and optimization of RAN elements and resources, Artificial Intelligence/Machine Learning (AI/ML) workflows including model training and updates, or policy-based guidance of applications/features in the near-RT RIC 225. The non-RT RIC 215 may be coupled to or communicate with (such as via an A1 interface) the near-RT RIC 225. The near-RT RIC 225 may be configured to include a logical function that enables near-real time control and optimization of RAN elements and resources via data collection and actions over an interface (such as via an E2 interface) connecting one or more CUs 210, one or more DUs 230, or both, as well as an O-eNB, with the near-RT RIC 225.

In some implementations, to generate AI/ML models to be deployed in the near-RT RIC 225, the non-RT RIC 215 may receive parameters or external enrichment information from external servers. Such information may be utilized by the near-RT RIC 225 and may be received at the SMO framework 205 or the non-RT RIC 215 from non-network data sources or from network functions. In some examples, the non-RT RIC 215 or the near-RT RIC 225 may be configured to tune RAN behavior or performance. For example, the non-RT RIC 215 may monitor long term trends and patterns for performance and employ AI/ML models to perform corrective actions through the SMO framework 205 (such as reconfiguration via 01) or via creation of RAN management policies (such as A1 policies).

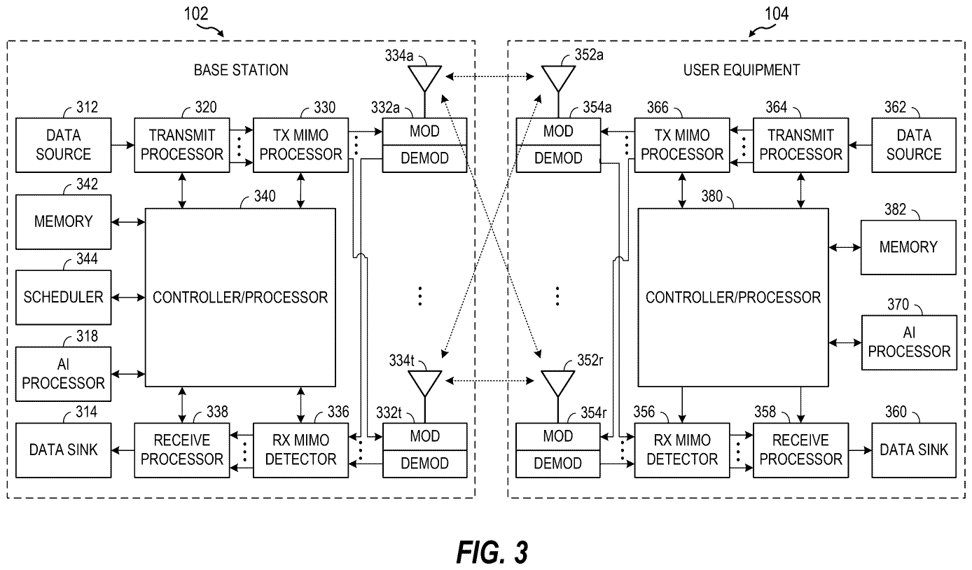

FIG. 3 depicts aspects of an example BS 102 and a UE 104. Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described related to wireless communications.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described.

In various aspects, UE 104 may likewise be described as transmitting and receiving various types of data associated with the methods described. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described.

In some aspects, a processor may be configured to perform various operations, such as those associated with the methods described, and transmit (output) to or receive (obtain) data from another interface that is configured to transmit or receive, respectively, the data.

In some aspects, the UE 104 and/or base station 102 may include means for selecting, means for transmitting, means for receiving, means for selecting, means for retransmitting, and means for configuring. Such means may include one or more components of the UE 104 or base station 102 described in connection with FIG. 3.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

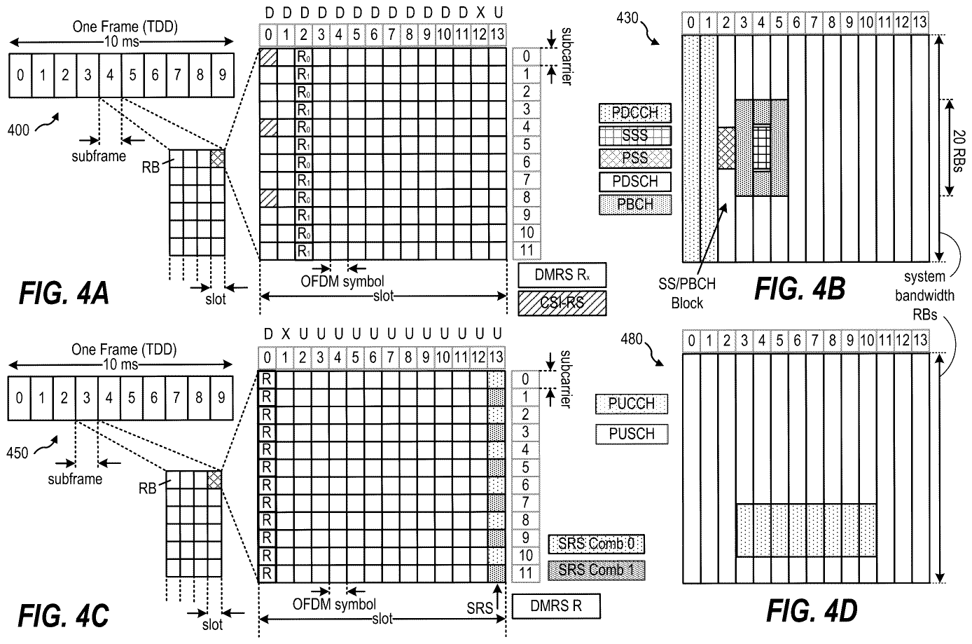

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency-domain subcarrier spacing and symbol duration as further described. In certain aspects, given a numerology μ, there are 2μ slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the physical uplink shared channel (PUSCH). The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Channel State Feedback

In certain wireless communications systems, closed-loop feedback associated with a communication channel between a UE and a network entity may be used to dynamically adapt communication parameters to channel conditions that may change over time. In certain cases, a UE may transmit a reference signal (e.g., DMRS, SRS, etc.), and a network entity (or another UE) may determine characteristics associated with the channel based on measurements of the received reference signal. In some cases, a UE may receive a reference signal (e.g., synchronization signal block (SSB), CSI-RS, DMRS, PT-RS, etc.) from a network entity (or another UE) and report channel state feedback to the network entity (or the other UE), where the channel state feedback is determined based on measurements of the reference signal received at the UE.

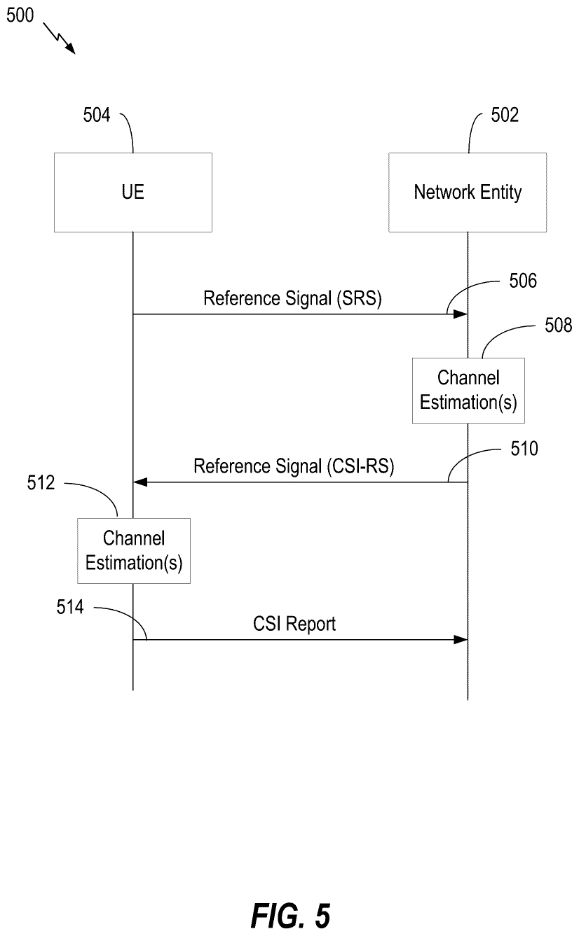

FIG. 5 depicts a process flow 500 for closed-loop feedback associated with a communication channel between a network entity 502 (e.g., BS 102) and a UE 504 (e.g., UE 104).

At time 506, the UE 504 may send a reference signal (e.g., DMRS, PT-RS, SRS, etc.) to the network entity 502. In certain aspects, the UE 504 may send the reference signal using one or more antenna ports, which may correspond to an SRS port or SRS antenna port. Transmission of the SRS via the one or more antenna ports may enable the network entity 502 to deduce the downlink propagation channel associated with the one or more antenna ports based on channel reciprocity.

At time 508, the network entity 502 performs channel calculations based on the reference signal, such as determining a channel estimate H based on the received reference signal, for example, as further described with respect to the UE 504 performing channel calculations at time 512. In certain aspects, the network entity 502 may further calculate, as part of the channel calculations, a precoder (e.g., precoder matrix) V based on the channel estimate H, for example, as further described with respect to the UE 504 performing such a calculation. Accordingly, the network entity 502 may determine H and/or V for an uplink channel between the UE 504 and the network entity 502 based on SRS. Further, the uplink channel between the UE 504 and the network entity 502 may have reciprocity with a downlink channel between the UE 504 and the network entity 502. Accordingly, the determined values of H and/or V for the uplink channel between the UE 504 and the network entity 502 may be used for the downlink channel between the UE 504 and the network entity 502. In some cases, the reciprocity between the uplink channel and the downlink channel may be based on a known difference between the uplink channel and the downlink channel, such that the difference can be represented by a function. Accordingly, in certain aspects, to determine H and/or V for the downlink channel, the network entity 502 may apply a function to H and/or V determined for the uplink channel.

At time 510, the UE 504 receives a reference signal (e.g., SSB, CSI-RS, etc.) from the network entity 502. In certain aspects, the network entity 502 may send the reference signal with precoding (e.g., beamforming, MIMO layer(s), and/or compensation for signal propagation effects) based on the channel estimate and/or precoder determined at 508. “Receiving a reference signal” may include measuring the reference signal, detecting the reference signal, or the like.

At time 512, the UE 504 performs channel calculations based on the reference signal, such as determining a channel estimate H based on the received reference signal. For example, the UE 504 may include a demodulator, which may be part of a transceiver (e.g., transceiver 354 of FIG. 3), RX MIMO detector (e.g., RX MIMO detector 356 of FIG. 3), and/or receive processor (e.g., receive processor 358 of FIG. 3) of the UE 504. The demodulator, such as a component of the demodulator, may take as input the reference signal as received over multiple antennas of the UE 504 and output a vector \vec{y} that is a representation of the received reference signal as received over each of the multiple antennas of the UE 504.

Based on a received signal model, the vector \vec{y} can be represented as follows in equation (1):

$$\vec{y} = H \vec{x} + \vec{n} \qquad ( 1 )$$

In equation (1), H corresponds to a matrix representation of the communications channel, as in a channel estimate of the communications channel over which the signal is communicated (e.g., downlink communication channel where the reference signal is communicated), \vec{x} is a vector representing symbols transmitted by the network entity 502 over a number of spatial layers, and \vec{n} is noise across the communications channel. In certain aspects, H has a size based on the number of antennas used to receive the signaling (Nₐₙₜ) and the number of spatial layers, Nₗ. For example, H may have a number of rows equal to Nₐₙₜ and a number of columns equal to Nₗ. In certain aspects, the symbols that form the reference signal are known by the UE 504 (e.g., configured or preconfigured at the UE 504). The UE 504 can determine the channel estimate H based on receiving the reference signal.

In certain aspects, the UE 504 may further calculate, as part of the channel calculations, a precoder (e.g., precoder matrix) V based on the channel estimate H. For example, the UE 504 may be configured to perform singular value decomposition (SVD)-based precoding to determine the precoder V. For example, SVD(H)=[U S V^{H}], such that SVD provides the precoder V. U may be related to the ordering of the rows of H, as in the ordering of the antennas as represented by H. It should be understood that other suitable techniques may be used to determine the precoder V based on the channel estimate H.

At time 514, the UE 504 may transmit, and the network entity 502 may receive, a CSI report. For example, the UE 504 may transmit the CSI report on a resource of an uplink resource pool in the absence of an uplink grant. The CSI report may include any one or more CSI parameters, such as a CQI, an LI, an RI, a PMI, or the like.

### Connectionless Uplink Resources to Facilitate CSI Reporting

Aspects of the present disclosure provide techniques for reducing collisions in connectionless CSI reporting.

### Example Operations of Entities in a Communications Network

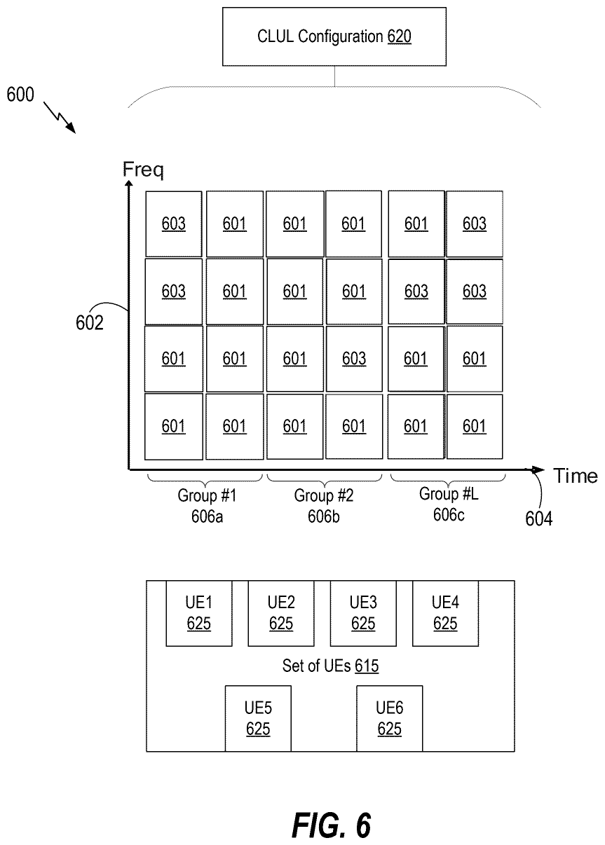

FIG. 6 is a block diagram illustrating a resource pool 600 of resources grouped and associated with connectionless uplink (CLUL) transmissions, according to various aspects of the present disclosure. In some aspects, the resource pool 600 may be referred to as an uplink resource pool.

The resource pool 600 may be associated with a set of UEs 615. The set of UEs 615 includes one or more UEs 625. For example, the resource pool 600 may be configured for the set of UEs 615, such as by transmitting configuration information to the set of UEs 615. In some aspects, the resource pool 600 may be associated with a specific type of transmission. For example, the resource pool 600 can be configured exclusively for CLUL transmission of CSI or for the set of UEs 615. The resource pool 600 may be comprised of available resources 601 or unavailable resources 603. The unavailable resources 603 may be already assigned to, reserved for, or currently in use by a UE 625 of the associated set of UEs 615.

A CLUL configuration 620 (sometimes referred to as a CLUL resource pool configuration or as a configuration) may define resources to be utilized for CLUL transmissions or for any other purpose or type of transmission. The CLUL configuration 620 can indicate one or more resource-related configurations. For example, the CLUL configuration 620 may indicate an amount of resources available for a specific purpose or type of transmission. As another example, the CLUL configuration 620 may indicate a use for a specific resource or group of resources (e.g., may indicate that the resource or group of resources is for CLUL transmission of CSI). As another example, the CLUL configuration 620 may indicate how resources are grouped (e.g., may indicate that a set of resources belong to a group, as defined below). As another example, the CLUL configuration 620 may indicate a relationship between one or more UEs 625 or sets of UEs 615 and resources or groups of resources (e.g., may indicate that a set of UEs 615 is associated with a specific group of resources for CLUL transmission of CSI). Because the reception at the NE is blind decoding-based, the NE may configure the resource pool 600 based on both traffic needs and NE processing capability.

In some aspects, the CLUL configuration 620 comprises a CSI-RS resource configuration. The CLUL configuration 620 may include one or multiple CSI-RS resource identifiers or indicators of CSI-RS resources associated with (e.g., belonging to) the resource pool 600. In some aspects, only periodic or semi-persistent CSI-RS resources may be included in the resource pool 600. For example, the resource pool 600 may omit aperiodic CSI-RS resources. In some aspects, the CLUL configuration 620 includes a list of CSI-RS resources or a CSI report setting configuration.

In some aspects, an SS/PBCH block (SSB) index may be configured for a CSI-RS resource. For example, each CSI-RS resource of a CLUL configuration 620 may be configured with a respective SSB index. The SSB index can be used for determining quasi co-location (QCL) relationships. A QCL relationship indicates a QCL source for a signal. The QCL source may be another signal or a resource from which QCL parameters (e.g., a spatial parameter, a delay parameter, or a Doppler parameter) for the signal are to be derived. In this example, an SSB associated with a given SSB index may be the QCL source for the CSI-RS resource.

In some aspects, the resource pool 600 for CSI reporting is separately configured relative to other resource pools for other types of transmissions. For example, the resource pool 600 may not be shared with other resource pools for the other types of transmissions. For example, the resource pool 600 may be configured by the CLUL configuration 620 to be used only for CSI reporting. In this example, the resources 601, 603 of the resource pool 600 may not be shared with other resource pools and may not be usable for other types of transmission, such as any non-CSI CLUL transmission (e.g., small data transfers). In other aspects, the resource pool 600 is a common resource pool configured for multiple types of transmissions.

The resource pool 600 may be configured by a system information block (SIB). For example, the CLUL configuration 620 may be transmitted via the SIB. In such examples, the resource pool 600 may be shared by UEs 625 in an idle mode (e.g., RRC idle mode) or UEs 625 not configured with dedicated resources for CSI reporting. For example, a UE 625 may not be configured with dedicated resources for CSI reporting during a random access procedure, so the resource pool 600 may be shared by UEs 625 during the random access procedure. A network entity may transmit the SIB carrying the CLUL configuration 620.

In various aspects, the resource pool 600 is configured by a radio resource control (RRC) message. A network entity may transmit the RRC message. In some aspects, the resource pool 600 may be dedicated to a group of UEs 625 in a connected mode (e.g., RRC connected mode). In some aspects, a UE identifier can be configured and used for identification during CSI reporting. For example, when transmitting a CSI report on a resource of the resource pool 600, a UE 625 of a group of UEs 625 for which the resource pool 600 is configured may provide a corresponding UE identifier, such that the UE 625 can be differentiated from other UEs of the group of UEs 625. In some aspects, the group may be the set of UEs 615.

In various aspects, the CLUL configuration 620 includes one or more CSI report setting configurations. A CSI report setting configuration may indicate a configuration to be used for CSI measurements and estimations, such as to perform measurements, calculations, or estimations of CSI. In some aspects, the CSI report setting configuration may exclude certain parameters that would ordinarily be included. For example, the CSI report setting configuration may omit a parameter that indicates a reporting granularity in the frequency-domain (e.g., a “reportFreqConfiguration” parameter). This is because, in some aspects, the UE 625 determines how complex the CSI is and whether to report wideband or subband CSI via the CLUL resource, so an explicit configuration of the reporting granularity can be avoided.

In some aspects, the CSI report setting configuration may indicate a sub-configuration. For example, the CSI report setting configuration may indicate a list of sub-configurations. In some aspects, a sub-configuration may indicate a CSI-RS antenna port subset. A CSI-RS antenna port subset may indicate which antenna ports, of a set of antenna ports of a CSI-RS resource, are to be used to determine CSI. Additionally, or alternatively, a sub-configuration may indicate a CSI reporting configuration corresponding to a CSI reporting capability. For example, a UE 625 may transmit a CSI reporting capability that indicates one or more supported CSI reporting configurations (e.g., wideband, subband, Type II CSI, eType II CSI). The sub-configuration may indicate one or more of these supported CSI reporting configurations. When transmitting CSI on the resource pool 600, the UE 625 may determine the CSI and/or report the CSI in accordance with a sub-configuration of the CSI report setting configuration, which may be associated with the resource pool 600 (for example, by way of being configured in the CLUL configuration 620) or an available resource 601 used to transmit the CSI.

In some aspects, the CLUL configuration 620 may indicate an uplink channel type (e.g., a PUCCH channel type or a PUSCH channel type). For example, the CLUL configuration 620 may indicate whether the UE 625 is to transmit CSI reporting via a PUCCH or a PUSCH. When indicating the PUCCH channel type in the CLUL configuration 620 for the transmission of CSI, the CLUL configuration 620 may indicate a PUCCH format and a maximum coding rate. When indicating the PUSCH channel type in the CLUL configuration 620 for the transmission of CSI, the CLUL configuration 620 may indicate at least one of a modulation and coding scheme (which may indicate a modulation order and a code rate for the PUSCH), a demodulation reference signal configuration (which may indicate time- or frequency-domain placement of one or more demodulation reference signals in the PUSCH), a time-domain resource for transmission of the PUSCH, a frequency-domain resource for transmission of the PUSCH, a multiplexing parameter (such as an indication of a number of time-division multiplexed or frequency-division multiplexed PUSCHs in a slot), or a CSI coding rate offset (sometimes referred to as a beta offset for a CSI coding rate). As mentioned, in some aspects, the CLUL configuration 620 may indicate a CSI coding rate parameter, such as a CSI coding rate offset or a maximum coding rate.

A resource of the resource pool 600 may be defined by a time-domain resource allocation (illustrated on the horizontal axis by reference number 604) and a frequency-domain resource allocation (illustrated on the vertical axis by reference number 602). The time-domain resource allocation may be in terms of slots, symbols, subframes, or the like. The frequency-domain resource allocation may be in terms of subchannels, resource blocks, or the like. Additional details regarding time- and frequency-domain resource definitions are provided in connection with FIGS. 4A-4D. Other parameters may additionally or alternatively define a resource, such as an index corresponding to the resource.

The resources 601, 603 of the resource pool 600 can be grouped in a variety of ways. Thus, the resource pool 600 may be partitioned into a set of groups 606. For example, a set of groups 606 may be defined in the time-domain resource allocation across a range of frequencies. Each group 606a, 606b, 606c of the set of groups 606 may contain a number of resources 601, 603 from the resource pool 600. For example, a group of the set of groups 606 may be defined in terms of a set of time resources included in the group. Different groups of the set of groups 606 may include different time resources, and each group of the set of groups 606 may include the same frequency resources. In some aspects, a group 600 may be defined in the frequency-domain (e.g., a set of groups 606 may be defined in the frequency-domain across a range of times). For example, different groups of the set of groups 606 may include different frequency resources, and each group of the set of groups 606 may include the same time resources. In some aspects, an available resource 601 may be included in multiple groups of the set of groups 606.

For relatively large cell sizes, a UE may need to acquire timing first before transmission. Moreover, because the CLUL transmissions are contention-based, CSI reporting of two or more UEs 625 may collide on a resource 601 or 603 if resources are randomly selected by the UEs. For example, a first UE 625 and a second UE 625 of the set of UEs 615 may attempt to send CSI over the same resource 601 or 603. In these instances, the NE may reschedule a colliding transmission (that is, a transmission of one of the first UE 625 or the second UE 625) to an available resource 601. In some aspects, UEs can schedule or reserve available resources 601 of the resource pool 600, thereby avoiding collisions in the resource pool 600. Additionally, or alternatively, UEs 625 may be associated with priorities for use of available resources 601, which may assist with resolving potential collisions. In still further aspects, a backoff mechanism may be employed to reduce or even minimize collisions.

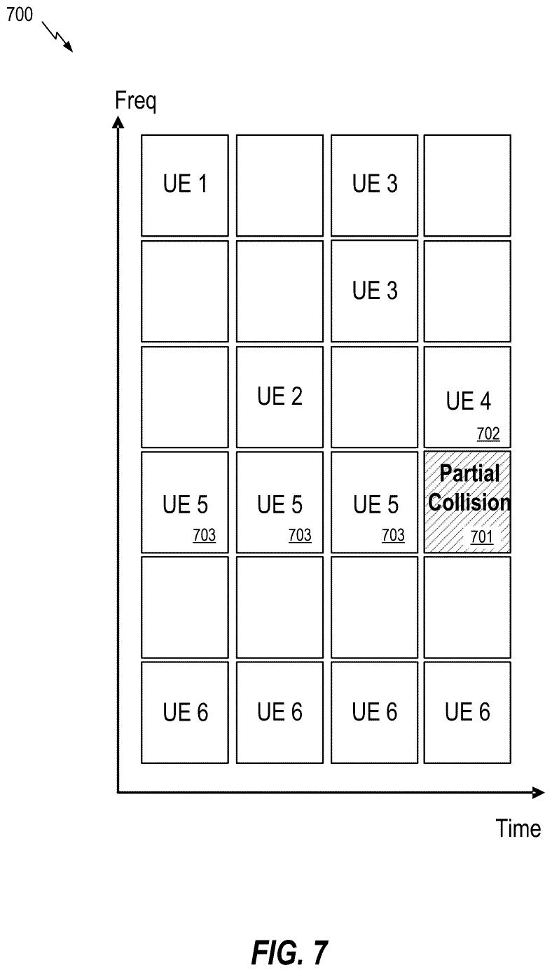

FIG. 7 is a diagram illustrating collisions in CLUL transmissions. In the example of FIG. 7, six UEs (UE 1, UE 2, UE 3, UE 4, UE 5, and UE 6) transmit on resources in a CLUL resource pool 700. As seen in FIG. 7, both UE 4 and UE 5 transmit on the resource 701, resulting in a partial collision. More specifically, UE 4 transmits on resources 701 and 702, while UE 5 transmits on resources 703 and 701. Aspects of the present disclosure introduce a backoff mechanism based on a CSI report to reduce or even minimize collisions between CLUL transmissions. Other aspects of the present disclosure relate to reliable delivery of packets, including reception acknowledgement and retransmission mechanisms for CLUL communications.

As previously noted, a target use case for CLUL is a large number of UEs, both enhanced mobile broadband (eMBB) and Internet of things (IoT) UEs camping on a carrier. The UEs may be in either connected mode or idle mode and may have a relatively low duty cycle for communications traffic. The CLUL communications may consist of relatively small packets transmitted on the uplink. A goal of CLUL is to allow these UEs to transmit the uplink data with reduced overhead. The overhead to reduce includes physical random access channel (PRACH), scheduling request (SR), buffer status report (BSR), uplink grant, and channel state information reference signal (CSI-RS) messages.

Aspects of the present disclosure introduce a backoff at the UE for transmitting in the resource pool. A backoff refers to a delayed transmission at the UE. The backoff may be based on a change in CSI such that UEs with lower change of CSI may transmit later than UEs with higher change of CSI. For example, a UE may apply the backoff based on one or more of a change in rank indicator (RI), a change in a channel quality indicator (CQI) index, and/or a change in a precoding matrix indicator (PMI) or a long term channel properties matrix (e.g., a W1 matrix).

A mapping from a change in a CSI report to an applied backoff may be provided by the NE. The NE may dynamically vary the mapping based on traffic patterns.

In some aspects, the NE may inform the backoff mapping based on a change of RI. For example, if the rank of the channel reduces, then the NE may configure certain backoff values. On the other hand, if the rank of the channel increases, then the NE may configure other backoff values. The NE may prioritize UEs with a decreased rank over those UEs with an increased rank. Such prioritization may prevent packet failures for the UE with a decreased rank.

In other aspects, the NE may inform the backoff mapping based on a change in a CQI index. For each change in CQI index, the NE may configure certain backoff values. The NE may also allocate a set of backoff values to a set of CQI index changes. The NE may prioritize UEs with a CQI index that has significantly reduced (e.g., UEs with a bad channel) over UEs with a CQI index that has increased (e.g., UEs with a good channel). This prioritization may prevent packet failures for the UEs with reduced CQI indexes.

In other aspects, the NE may inform the backoff mapping based on a change in PMI. The backoff may be based on a change of channel state in a previous beam direction. The NE may indicate the dynamic variation of the backoff value with the change in CSI to the UEs through a group common physical downlink control channel (GC-PDCCH). The NE may provide an initial backoff configuration with radio resource control (RRC) signaling. The initial backoff configuration may indicate an initial mapping of backoff values to CSI changes. A backoff value may prioritize a UE having a higher change in PMI than a previous change in PMI.

According to aspects of the present disclosure, the NE may reserve a set of resources in the resource pool for a given CSI change. The UE then randomly selects a resource in the set based on a CSI change. The resource set may be initially indicated with RRC signaling. The GC-PDCCH signaling may indicate a dynamic variation of the backoff value with respect to a CSI change. The resources may be specifically allocated or may be a nested allocation. The allocated range for the backoff value or for the set of resources allocated for a CSI change is up to NE implementation. For example, the NE may allocate higher resources for a significant change in CSI compared to a smaller change in CSI to reduce the collisions for users with a higher change in CSI.

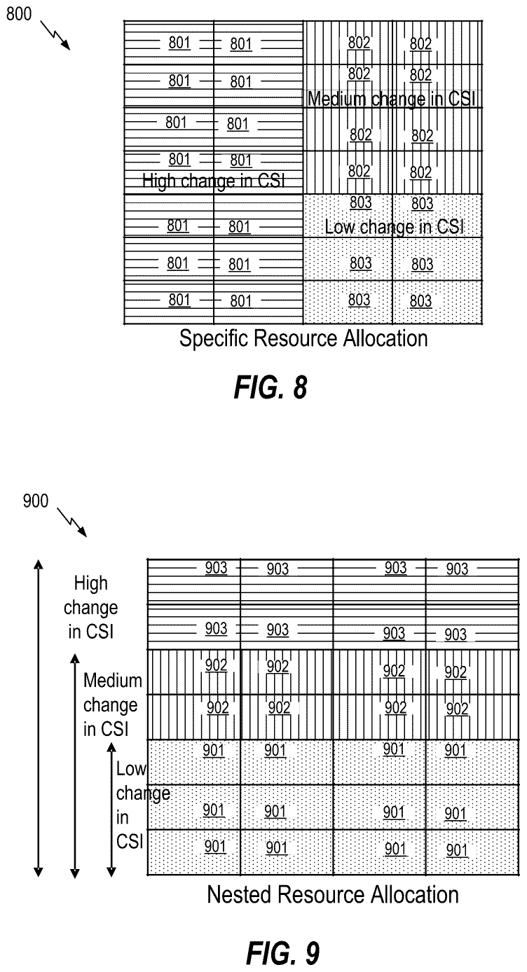

FIG. 8 is a diagram illustrating a specific resource allocation 800, in accordance with various aspects of the present disclosure. In the example of FIG. 8, a first set of resources 801 may be allocated to UEs with a high change in CSI. A second set of resources 802 may be allocated to UEs with a medium change in CSI. A third set of resources 803 may be allocated to UEs with a low change in CSI. Thus, based on the change in CSI, the UE randomly selects a resource from the appropriate resource set 801-803.

The NE may also allocate nested resources for the changes in CSI. The NE may restrict users with a low change in CSI to transmit from certain resources, whereas users with a high change in CSI may transmit in any resource.

FIG. 9 is a diagram illustrating a nested resource allocation 900, in accordance with various aspects of the present disclosure. In the example of FIG. 9, a first set of resources 901 may be allocated to UEs with a low change in CSI (e.g., below a threshold value). A UE with a low change in CSI may randomly select a resource from the first set of resources 901. A second set of resources 902 may be allocated to UEs with a medium change in CSI. A UE with a medium change in CSI may randomly select a resource from the first set of resources 901 or the second set of resources 902. A third set of resources 903 may be allocated to UEs with a high change in CSI (e.g., above a threshold value). A UE with a high change in CSI may randomly select a resource from the first set of resources 901, the second set of resources 902, or the third set of resources 903.

Various retransmission mechanisms will now be described for retransmission of CSI reports in case of failure when transmitting the CSI reports. In a first option, acknowledgements and negative acknowledgements (ACK/NACK) are not transmitted for CSI reports because CSI changes rapidly and CSI reports are transmitted frequently. In this option, if an NE does not receive a CSI report from a UE for a long period of time due to collisions, then the NE may allocate resources in a specific uplink (UL) grant for the user to transmit a CSI report. The uplink grant may be received using DCI based on a user ID (e.g., cell radio network temporary identifier (C-RNTI) or inactive radio network temporary identifier (I-RNTI)). After receiving the uplink grant, the UE transmits the CSI report in the allocated uplink resources. This option assumes that there is a separate UL resource pool for the CSI report, and the NE knows the data detected in the resource pool corresponds to the CSI report.

In a second option, if the NE elects to transmit ACK/NACK for a CSI report, or there is a common resource pool for both the CSI report and other uplink data, then the NE may follow ACK/NACK procedures as follows. The ACK/NACK in this option occurs because the NE does not know whether a detected transmission from the common resource pool is a CSI report or another type of transmission.

The NE may transmit DCI with ACK/NACK bits mapping to CLUL resource IDs. That is, the ACK/NACK feedback is based on a bitmap. A same number of ACK/NACK bits and resource IDs are present in the bitmap. For example, if 28 resource IDs are present, then 28 bits are provided for ACK/NACK feedback. In this implementation, the UE detects if there is a success or failure for CSI report transmission, and then chooses to retransmit the CSI report depending on an amount of CSI change. The NE may configure rules for retransmission based on the CSI change. For example, the retransmission may occur only if the CSI change is more than 20%.

In another implementation, the NE transmits user ID specific ACK feedback. In this implementation, the ACK feedback may be cyclic redundancy check (CRC) data scrambled with the user ID. Thus, the UE knows when a CSI report is transmitted successfully. UEs not receiving explicit ACK feedback may decide to retransmit the CSI report based on a CSI change.

In yet another implementation, the NE transmits downlink control information with an explicit uplink grant. For example, the NE may detect transmission through a demodulation reference signal (DMRS) but may not successfully decode the uplink data. In this implementation, the NE may transmit an explicit grant based on the resource ID of the resource in the resource pool. The UE may choose to retransmit the CSI report using the explicit grant based on a change in CSI.

Particular aspects of the subject matter described in this disclosure can be implemented to realize one or more of the following potential advantages. In some examples, the described backoff techniques may reduce power consumption, reduce processing, and reduce signaling overhead by reducing collisions for both initial transmissions and retransmissions.

### Example Operations of a User Equipment and a Network Entity

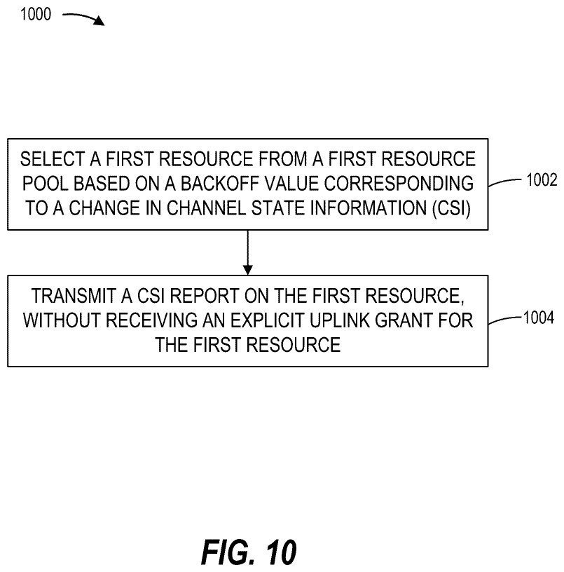

FIG. 10 is a flow diagram illustrating an example process 1000 for communicating information via connectionless uplink resources from a UE, e.g., UE 104, or UE 625, according to various aspects of the present disclosure.

At block 1002, the process 1000 may select a first resource from a first resource pool based on a backoff value corresponding to a change in channel state information (CSI). For example, the UE (e.g., using the controller/processor 380, memory 382 and/or the like) may select the first resource. In some implementations, the backoff value is based on a change in rank indicator (RI). The backoff value may also be based on a change in a channel quality indicator (CQI) index, and/or a change in a precoding matrix indicator (PMI) or a wideband and long term channel properties matrix.

At block 1004, the process 1000 may transmit a CSI report on the first resource, without receiving an explicit uplink grant for the first resource. For example, the UE (e.g., using the antenna 352, the MOD/DEMOD 354a, TX MIMO processor 366, transmit processor 364, controller/processor 380, memory 382 and/or the like) may transmit the CSI report. In some aspects, the method also includes retransmitting the CSI report in resources allocated by an uplink grant. In other aspects, the method includes retransmitting the CSI report in response to receiving a negative acknowledgement (NACK) for the CSI report, the retransmitting occurring in a second resource selected from a second resource pool when an amount of change in CSI is greater than a threshold value. In still other aspects, the method includes retransmitting the CSI report in response to not receiving a user identifier (ID) specific ACK for the CSI report, the retransmitting occurring in a second resource selected from a second resource pool when an amount of change in CSI is greater than a threshold value.

Note that FIG. 10 is just one example of a method, and other methods including fewer, additional, or alternative steps are possible consistent with this disclosure.

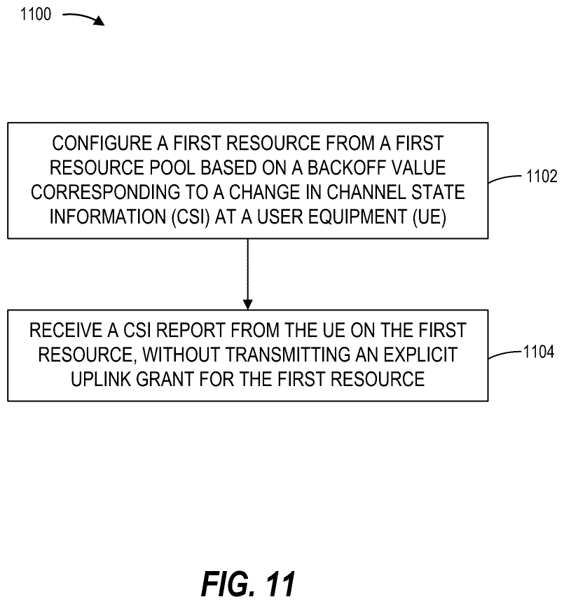

FIG. 11 is a flow diagram illustrating an example process 1100 for communicating information via connectionless uplink resources from a network entity, e.g., base station 102, according to various aspects of the present disclosure.

At block 1102, the process 1100 may configure a first resource from a first resource pool based on a backoff value corresponding to a change in channel state information (CSI) at a user equipment (UE). For example, the network entity (e.g., using the controller/processor 340, memory 342 and/or the like) may configure the first resource. In some implementations, the backoff value is based on a change in rank indicator (RI). The backoff value may also be based on a change in a channel quality indicator (CQI) index, and/or a change in a precoding matrix indicator (PMI) or a wideband and long term channel properties matrix.

At block 1104, the process 1100 may receive a CSI report from the UE on the first resource, without transmitting an explicit uplink grant for the first resource. For example, the network entity (e.g., using the antenna 334, the MOD/DEMOD 332a, RX MIMO detector 336, receive processor 338, controller/processor 340, memory 342 and/or the like) may receive the CSI report. In some aspects, the method also includes receiving a retransmission of the CSI report in resources allocated by an uplink grant.

Note that FIG. 11 is just one example of a method, and other methods including fewer, additional, or alternative steps are possible consistent with this disclosure.

### Example Clauses

Aspect 1: A method of connectionless uplink (CLUL) wireless communication, at a user equipment (UE), comprising: selecting a first resource from a first resource pool based on a backoff value corresponding to a change in channel state information (CSI); and transmitting a CSI report on the first resource, without receiving an explicit uplink grant for the first resource.

Aspect 2: The method of Aspect 1, in which the backoff value is based on a change in rank indicator (RI).

Aspect 3: The method of any of the preceding Aspects, in which the backoff value prioritizes the UE in response to the RI decreasing.

Aspect 4: The method of any of the preceding Aspects, in which the backoff value is based on a change in a channel quality indicator (CQI) index.

Aspect 5: The method of any of the preceding Aspects, in which the backoff value prioritizes the UE in response to the CQI index decreasing.

Aspect 6: The method of any of the preceding Aspects, in which the backoff value is based on a change in a precoding matrix indicator (PMI) or a wideband and long term channel properties matrix.

Aspect 7: The method of any of the preceding Aspects, in which the backoff value prioritizes the UE in response to the PMI increasing more than a previous PMI change.

Aspect 8: The method of any of the preceding Aspects, further comprising receiving a group common physical downlink control channel (GC-PDCCH) indicating a dynamic variation of the backoff value with respect to a CSI change.

Aspect 9: The method of any of the preceding Aspects, further comprising receiving radio resource control (RRC) signaling indicating an initial mapping of backoff values to CSI changes.

Aspect 10: The method of any of the preceding Aspects, further comprising applying the backoff value by selecting the first resource from reserved resources in the first resource pool.

Aspect 11: The method of any of the preceding Aspects, in which the reserved resources comprise nested resources, a first set of nested resources corresponding to a CSI change below a threshold value and a second set of nested resources corresponding to a CSI change above the threshold value, the second set of nested resources also including the first set of nested resources.

Aspect 12: The method of any of the preceding Aspects, in which the first resource pool is allocated exclusively for CSI reporting and the UE does not expect to receive acknowledgement/negative acknowledgement (ACK/NACK) feedback for the CSI report.

Aspect 13: The method of any of the preceding Aspects, further comprising: receiving an uplink grant allocating resources for retransmitting the CSI report in response to a network device not receiving the CSI report for longer than a predetermined time period; and retransmitting the CSI report in the resources allocated by the uplink grant.

Aspect 14: The method of any of the preceding Aspects, further comprising receiving downlink control information (DCI) with acknowledgement/negative acknowledgement (ACK/NACK) bits for the CSI report, the ACK/NACK bits mapping to a CLUL resource ID of the first resource.

Aspect 15: The method of any of the preceding Aspects, further comprising retransmitting the CSI report in response to receiving a negative acknowledgement (NACK) for the CSI report, the retransmitting occurring in a second resource selected from a second resource pool when an amount of change in CSI is greater than a threshold value.

Aspect 16: The method of any of the preceding Aspects, further comprising receiving a user identifier (ID) specific acknowledgement (ACK) for the CSI report.

Aspect 17: The method of any of the preceding Aspects, further comprising retransmitting the CSI report in response to not receiving the user ID specific ACK for the CSI report, the retransmitting occurring in a second resource selected from a second resource pool when an amount of change in CSI is greater than a threshold value.

Aspect 18: The method of any of the preceding Aspects, further comprising: receiving downlink control information (DCI) carrying an uplink grant for resources allocated for retransmitting the CSI report based on an identifier (ID) of the first resource; and retransmitting the CSI report using the resources allocated by the uplink grant.

Aspect 19: A method of connectionless uplink (CLUL) wireless communication, at a network entity, comprising: configuring a first resource from a first resource pool based on a backoff value corresponding to a change in channel state information (CSI) at a user equipment (UE); and receiving a CSI report from the UE on the first resource, without transmitting an explicit uplink grant for the first resource.

Aspect 20: The method of Aspect 19, in which the backoff value is based on a change in rank indicator (RI).

Aspect 21: The method of Aspect 19 or 20, in which the backoff value prioritizes the UE in response to the RI decreasing.

Aspect 22: The method of Aspect 19, 20, or 21, in which the backoff value is based on a change in a channel quality indicator (CQI) index.

Aspect 23: The method of any of the Aspects 19-22, in which the backoff value prioritizes the UE in response to the CQI index decreasing.

Aspect 24: The method of any of the Aspects 19-23, in which the backoff value is based on a change in a precoding matrix indicator (PMI) or a wideband and long term channel properties matrix.

Aspect 25: The method of any of the Aspects 19-24, further comprising transmitting a group common physical downlink control channel (GC-PDCCH) indicating a dynamic variation of the backoff value with respect to a CSI change.

Aspect 26: The method of any of the Aspects 19-25, further comprising transmitting radio resource control (RRC) signaling indicating an initial mapping of backoff values to CSI changes.

Aspect 27: The method of any of the Aspects 19-26, further comprising: transmitting an uplink grant allocating resources for retransmitting the CSI report in response to not receiving the CSI report for longer than a predetermined time period; and receiving a retransmission of the CSI report in the resources allocated by the uplink grant.

Aspect 28: The method of any of the Aspects 19-27, further comprising transmitting downlink control information (DCI) with acknowledgement/negative acknowledgement (ACK/NACK) bits for the CSI report, the ACK/NACK bits mapping to a CLUL resource ID of the first resource.

Aspect 29: The method of any of the Aspects 19-28, further comprising transmitting a user ID specific acknowledgement (ACK) for the CSI report.

Aspect 30: The method of any of the Aspects 19-29, further comprising: transmitting downlink control information (DCI) carrying an uplink grant for resources allocated for retransmitting the CSI report based on an identifier (ID) of the first resource; and receiving a retransmission of the CSI report using the resources allocated by the uplink grant.

### ADDITIONAL CONSIDERATIONS

The preceding description is provided to enable any person skilled in the art to practice the various aspects described. The examples discussed are not limiting of the scope, applicability, or aspects set forth in the claims. Various modifications to these aspects will be readily apparent to those skilled in the art, and the general principles defined may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth. In addition, the scope of the disclosure is intended to cover such an apparatus or method that is practiced using other structure, functionality, or structure and functionality in addition to, or other than, the various aspects of the disclosure set forth. It should be understood that any aspect of the disclosure disclosed may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

As used, unless stated otherwise, the term “or” is used in an inclusive sense. This inclusive usage of or is equivalent to “and/or.” Thus, when options are delineated using “or,” it permits the selection of one or more of the enumerated options concurrently. For example, if the document stipulates that a component may comprise option A or option B, it shall be understood to mean that the component may comprise option A, option B, or both option A and option B, and does not mean, unless stated expressly that the component includes either option A or option B. This inclusive interpretation ensures that all potential combinations of the options are permissible, rather than restricting the choice to a singular, exclusive option.

The methods disclosed comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown, but are to be accorded the full scope consistent with the language of the claims. Reference to an element in the singular is not intended to mean only one unless specifically so stated, but rather “one or more.” The subsequent use of a definite article (e.g., “the” or “said) with an element (e.g., “the processor) is not intended to invoke a singular meaning (e.g., “only one) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed is intended to be dedicated to the public regardless of whether such disclosure is explicitly recited in the claims.

What is claimed is:

1. A method of connectionless uplink (CLUL) wireless communication, at a user equipment (UE), comprising:
selecting a first resource from a first resource pool based on a backoff value corresponding to a change in channel state information (CSI); and
transmitting a CSI report on the first resource, without receiving an explicit uplink grant for the first resource.

2. The method of claim 1, in which the backoff value is based on a change in rank indicator (RI).

3. The method of claim 2, in which the backoff value prioritizes the UE in response to the RI decreasing.

4. The method of claim 1, in which the backoff value is based on a change in a channel quality indicator (CQI) index.

5. The method of claim 4, in which the backoff value prioritizes the UE in response to the CQI index decreasing.

6. The method of claim 1, in which the backoff value is based on a change in a precoding matrix indicator (PMI) or a wideband and long term channel properties matrix.

7. The method of claim 6, in which the backoff value prioritizes the UE in response to the PMI increasing more than a previous PMI change.

8. The method of claim 1, further comprising receiving a group common physical downlink control channel (GC-PDCCH) indicating a dynamic variation of the backoff value with respect to a CSI change.

9. The method of claim 8, further comprising receiving radio resource control (RRC) signaling indicating an initial mapping of backoff values to CSI changes.

10. The method of claim 1, further comprising applying the backoff value by selecting the first resource from reserved resources in the first resource pool.

11. The method of claim 10, in which the reserved resources comprise nested resources, a first set of nested resources corresponding to a CSI change below a threshold value and a second set of nested resources corresponding to a CSI change above the threshold value, the second set of nested resources also including the first set of nested resources.

12. The method of claim 1, in which the first resource pool is allocated exclusively for CSI reporting and the UE does not expect to receive acknowledgement/negative acknowledgement (ACK/NACK) feedback for the CSI report.

13. The method of claim 12, further comprising:
receiving an uplink grant allocating resources for retransmitting the CSI report in response to a network device not receiving the CSI report for longer than a predetermined time period; and
retransmitting the CSI report in the resources allocated by the uplink grant.

14. The method of claim 1, further comprising receiving downlink control information (DCI) with acknowledgement/negative acknowledgement (ACK/NACK) bits for the CSI report, the ACK/NACK bits mapping to a CLUL resource ID of the first resource.

15. The method of claim 14, further comprising retransmitting the CSI report in response to receiving a negative acknowledgement (NACK) for the CSI report, the retransmitting occurring in a second resource selected from a second resource pool when an amount of change in CSI is greater than a threshold value.

16. The method of claim 1, further comprising receiving a user identifier (ID) specific acknowledgement (ACK) for the CSI report.

17. The method of claim 16, further comprising retransmitting the CSI report in response to not receiving the user (ID) specific ACK for the CSI report, the retransmitting occurring in a second resource selected from a second resource pool when an amount of change in CSI is greater than a threshold value.

18. The method of claim 1, further comprising:
receiving downlink control information (DCI) carrying an uplink grant for resources allocated for retransmitting the CSI report based on an identifier (ID) of the first resource; and
retransmitting the CSI report using the resources allocated by the uplink grant.

19. A method of connectionless uplink (CLUL) wireless communication, at a network entity, comprising:
configuring a first resource from a first resource pool based on a backoff value corresponding to a change in channel state information (CSI) at a user equipment (UE); and
receiving a CSI report from the UE on the first resource, without transmitting an explicit uplink grant for the first resource.

20. The method of claim 19, in which the backoff value is based on a change in rank indicator (RI).

21. The method of claim 20, in which the backoff value prioritizes the UE in response to the RI decreasing.

22. The method of claim 19, in which the backoff value is based on a change in a channel quality indicator (CQI) index.

23. The method of claim 22, in which the backoff value prioritizes the UE in response to the CQI index decreasing.

24. The method of claim 19, in which the backoff value is based on a change in a precoding matrix indicator (PMI) or a wideband and long term channel properties matrix.

25. The method of claim 19, further comprising transmitting a group common physical downlink control channel (GC-PDCCH) indicating a dynamic variation of the backoff value with respect to a CSI change.

26. The method of claim 25, further comprising transmitting radio resource control (RRC) signaling indicating an initial mapping of backoff values to CSI changes.

27. The method of claim 19, further comprising:
transmitting an uplink grant allocating resources for retransmitting the CSI report in response to not receiving the CSI report for longer than a predetermined time period; and
receiving a retransmission of the CSI report in the resources allocated by the uplink grant.

28. The method of claim 19, further comprising transmitting downlink control information (DCI) with acknowledgement/negative acknowledgement (ACK/NACK) bits for the CSI report, the ACK/NACK bits mapping to a CLUL resource ID of the first resource.

29. The method of claim 19, further comprising transmitting a user ID specific acknowledgement (ACK) for the CSI report.

30. The method of claim 19, further comprising:
transmitting downlink control information (DCI) carrying an uplink grant for resources allocated for retransmitting the CSI report based on an identifier (ID) of the first resource; and
receiving a retransmission of the CSI report using the resources allocated by the uplink grant.
